(19) United States
(12) Patent Application Publication
(10) Pub. No.: US 2015/0101488 A1
(43) Pub. Date: Apr. 16, 2015

(54) MACHINE FOR PREPARING BEVERAGES

(71) Applicant: Roberto Stefanoni, Oggiono (IT)

(72) Inventor: Roberto Stefanoni, Oggiono (IT)

(73) Assignee: IDES DEVELOPMENT COMPANY LIMITED, San Po Kong, Kowloon (HK)

(21) Appl. No.: 14/395,255

(22) PCT Filed: Apr. 19, 2012
(86) PCT No.: PCT/IT2012/000114

§ 371 Date: Dec. 16, 2014

(51) Int. Cl. A47J 31/40

(52) U.S. Cl. CPC A47J 31/407
USPC 99/295

(57) ABSTRACT

A machine for supplying beverages such as coffee and the like starting from a substantially granular preparation contained in single-dose capsules (C), which machine comprises an infusion group (100) which in turn has: an infusion seat (102), which is apt to receive the capsule during the beverage extraction performed by means for feeding hot water through the capsule itself; a lever for moving the capsule (2), apt to move the latter from an inlet position in the infusion group to an infusion position wherein the capsule is received in the infusion seat (102); and a perforating lever (1) of the capsule, distinct from the means for feeding an infusion liquid, wherein the whole configuration is so that the perforating means (1) perforates the capsule in a position of the latter previous to the infusion position (102), in particular in an inlet position in the machine (FIG. 3A).

### TECHNICAL FIELD OF THE INVENTION

The present invention relates to an infusion group to be used in a machine for supplying beverages such as coffee and the like starting from a substantially granular preparation contained in capsules.

The invention further relates to a machine for supplying beverages of the above-mentioned type comprising the infusion group mentioned above.

### BACKGROUND

On the market several types of machines for preparing infusions such as coffee, tea and the like, starting from a generally granular preparation contained in single-dose capsules, are known.

Such machines typically comprise a boiler wherein a liquid, generally water, is heated and brought under pressure, and a capsule-holding body associated to the boiler for extracting the infusion. The user inserts a new capsule in a specific inlet seat of the machine and, by actuating a lever, he/she presses the capsule inside an infusion seat. At this point, the liquid under pressure supplied by the boiler crosses the capsule and the produced infusion is extracted from the bottom of the capsule-holder. At the end of the infusion extraction phase, the capsule is removed, typically with automatic systems, so as to allow the preparation of a new beverage.

Some of the known capsules are sealed and they need a perforation of their own casing or their own wall to allow the inlet of infusion liquid. In the known machines, such perforation is performed by the same members which supply the infusion liquid in the capsule. To this end, such members are equipped with cutting ends to penetrate the capsule sealing. In the known machines the perforation takes place then when the capsule lies in the above-mentioned infusion seat.

The just described known machines have the drawback of requesting to implement members for feeding the infusion liquid which are also suitable to perform the capsule perforation, and which result then to be mechanically complex and intrinsically delicate.

Furthermore, the fact that the perforation takes place directly in the infusion seat substantially exactly in the same starting moment of the infusion—or one moment before it—makes that any drawback taking place in such perforating phase reflects immediately upon the operation of the whole machine.

At last, the perforating members and the infusion process in general which the machine implements have to be necessarily specific for the above-mentioned sealed capsules and they can be used then only with this type of capsules.

### SUMMARY OF THE INVENTION

The technical problem placed and solved by the present invention is then to provide an infusion group for a machine for supplying beverages such as coffee or the like from a substantially granular preparation contained in capsules which allows to obviate the drawbacks mentioned above with reference to the known art.

Such problem is solved by an infusion group according to claim 1 and by a machine of the above-mentioned type comprising it.

Preferred features of the present invention are object of the depending claims.

In the proposed infusion group, the capsule piercing is performed by means of perforating means distinct from the members for supplying infusion liquid in the capsule itself, in a capsule position different from the infusion one and previous with respect to the latter. This allows the separate handling of the perforation and subsequent infusion phases and therefore of the maintenance of the different components and it avoids that perforation problems compromise the operation of the infusion group as a whole and in particular of the most delicate components thereof, that is the boiler and the infusion head.

Furthermore, the perforation is performed in a simple and reliable way.

The proposed preferred solution, based thereupon a perforating lever is provided, which can be actuated by the mechanism implementing the capsule motion from the inlet thereof into the machine until reaching the infusion position, allows a simple adapting even of known machines to the use of sealed capsules.

Other advantages, features and use modes of the present invention will result evident from the detailed description of some embodiments, shown by way of example and not with limitative purpose.

### BRIEF DESCRIPTION OF THE FIGURES

The figures of the enclosed drawings will be referred to, wherein:

FIG. 1 shows a side perspective view of an infusion group according to a preferred embodiment of the invention, in a first rest configuration;

FIGS. 2A and 2B relate each one to the infusion group of FIG. 1, showing a side perspective view thereof and a top perspective view thereof in a second configuration for preparing to receive a capsule, respectively;

FIGS. 3A and 3B show each one a top perspective view of the infusion group of FIG. 1, respectively with and without inserted capsule (in the latter case for better clarity), in a third configuration for receiving a capsule prior to the perforation of the latter; and

FIGS. 4A to 4D relate each one to the infusion group of FIG. 1, showing a side perspective view thereof and a first, second and a third top perspective view in a fourth configuration for piercing the capsule, in case of FIG. 4D without inserted capsule for better clarity.

### DETAILED DESCRIPTION OF PREFERRED EMBODIMENTS

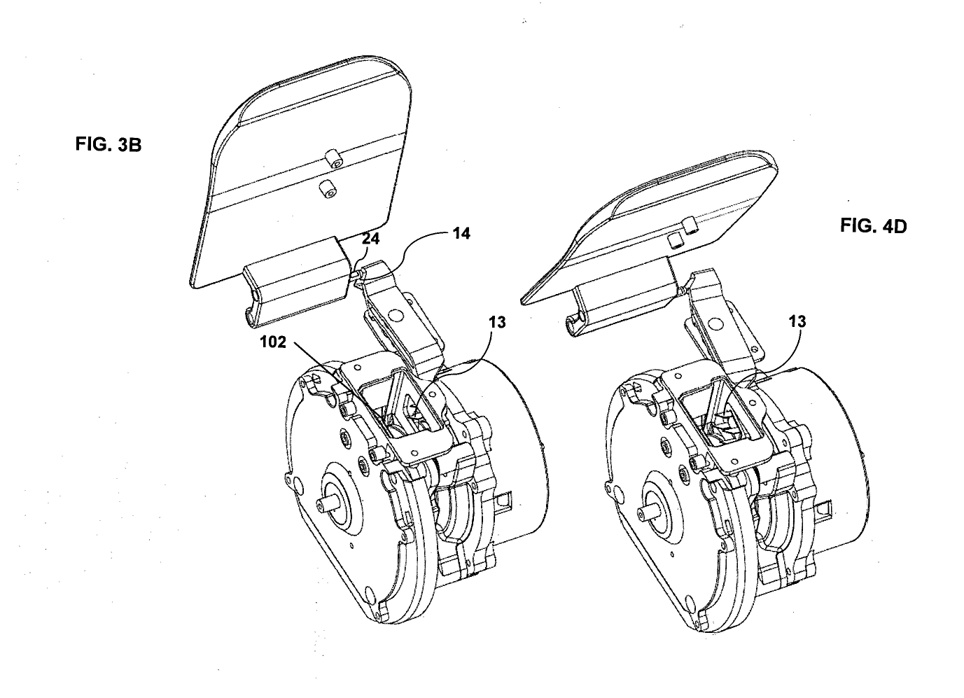

By firstly referring to FIGS. 3A and 3B, an infusion group according to a preferred embodiment of the invention is designated as a whole with 100.

Infusion group 100 is destined to be used with—and/or a portion of—a machine for supplying beverages such as coffee and the like starting from a substantially granular preparation contained in single-dose capsules.

The infusion group 100 comprises a main body 101, including a boiler apt to heat an infusion liquid, typically water, and an infusion head or equivalent members to feed such liquid within the capsule. During such infusion phase, the capsule (designated with C in FIG. 3A) is received in an infusion seat designated with 102. As the members of main body 101 mentioned in this case are already known in the art, one will not further dwell upon the description thereof.

A mechanism for moving the capsule, apt to move the latter from an inlet position in the machine to an infusion position wherein the capsule is received in the above-mentioned infusion seat 102, is associated to main body 101. The inlet position is defined by an inlet seat 103, connected to infusion seat 102 by means of a channel for moving the capsule wherein the latter can slide.

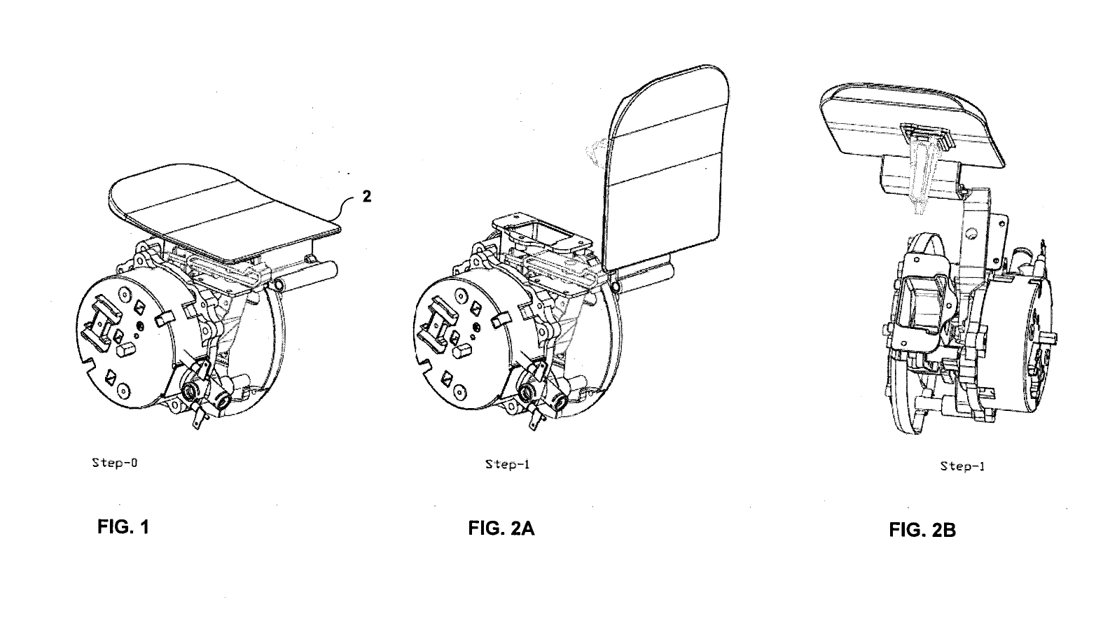

The above-mentioned moving mechanism too is generally known and it comprises a pushing lever 2 rotating about an axis 20. Such pushing lever 2 can be actuated by a user between a position for opening the inlet seat 103 shown in FIG. 3A and 3B and wherein the lever 2 is spaced apart from the main body 101—and a position for engaging such seat—shown for example in FIG. 1 and wherein the capsule has been pushed within the infusion seat 102. Indeed for pushing the capsule from inlet seat 103 to the infusion one 102, lever 2 has a projecting member for engaging the capsule designated with 21.

Infusion group 100 comprises then perforating means, designated as a whole with 1, apt to perforate the capsule prior to the infusion, when the capsule itself is in a previous position with respect to the receiving one in infusion seat 102. In the present example, such perforating means 1 is configured so as to perform the piercing of the capsule received in inlet seat 103.

Perforating means 1 comprises a lever member 11, preferably a lever of first class, rotating about a rotation axis 12. In the present arrangement, rotation axis 12 of perforating means 1 is substantially orthogonal to rotation axis 20 of the pushing lever 2.

Lever member 11 has one of more perforating members 13, preferably arranged at a longitudinal end portion of the lever member 11 and extending in direction orthogonal to the longitudinal development of the latter.

Typically one or each perforating member 13 is elongate, with a cutting projecting longitudinal end.

Perforating members 13 penetrate main body 101 at an opening 105 arranged at inlet seat 103.

Variant embodiments can provide that the capsule perforation takes place in an intermediate position of the capsule itself comprised between inlet seat 103 and infusion seat 102, that is when the capsule passes into the above-mentioned motion channel towards the infusion seat.

Perforating means 1 further comprises (not represented) contrast elastic means apt to oppose a removal of the perforating members 13 from the inlet seat 103 of the capsule. Such contrast elastic means is preferably arranged at rotation axis 12 and they can consist of a torsion spring.

Lever member 11 of perforating means 1 is actuated by pushing lever 2 by means of a shape coupling means. In the present example, the latter is a coupling between a pin 24 of lever 2 projecting orthogonally therefrom and a shaped surface 14, for example of cam-like type, of lever member 11. In the present example, cam-like surface 14 has an inclined profile.

The whole arrangement is so that the interaction between pin 24 and shaped surface 14 takes place at a first portion, or arm, 15 of lever member 11 arranged on opposite portion, with respect to rotation axis 12, of a second portion, or arm, 16 bearing perforating members 13.

The whole arrangement is so that when pin 24 acts onto the shaped surface 14 of lever arm 15 in the sense of removing the latter from pushing lever 2, an approaching of perforating members 13 to the capsule to be perforated is obtained. As mentioned above, the contrast means is configured so as to assist this motion and to oppose the opposed motion, that is a removal of perforating members 13 from the capsule.

The whole operating modes of infusion group 100 will be illustrated hereinafter by referring to the phase sequence represented in FIGS. 1 to 4D.

In FIG. 1, infusion group 100 is shown in a rest configuration wherein the pushing lever 2 is closed again onto inlet seat 103.

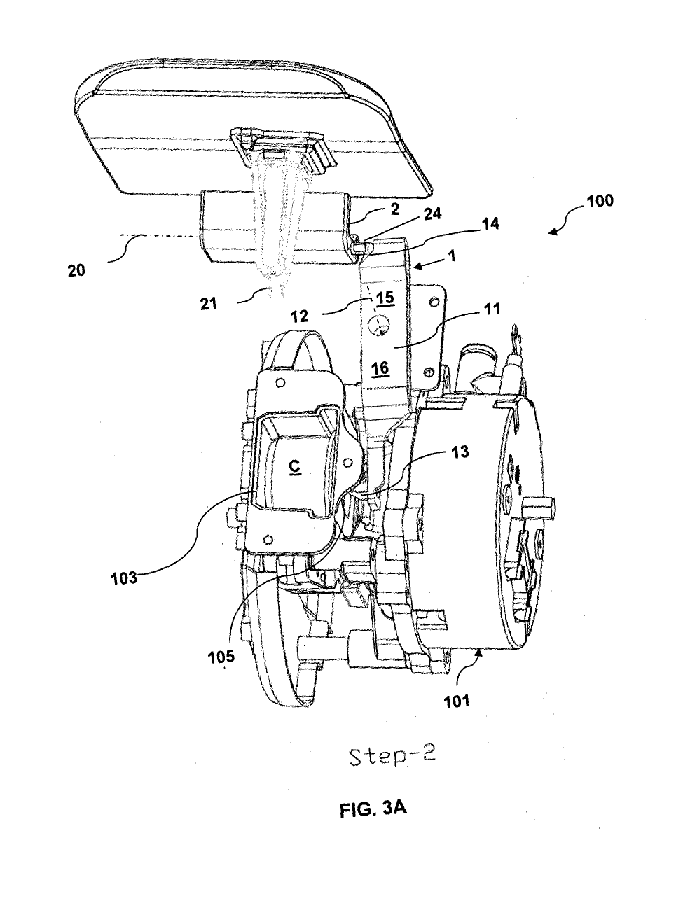

As shown in FIGS. 2A and 2B, when the user wishes to prepare a beverage, he/she seizes pushing lever 2 and rotates it in a position of whole disengagement of the inlet seat 103, which in FIGS. 2A and 2B is a raised position substantially orthogonal to the rest position of FIG. 1.

As shown in FIG. 3A, the user inserts then a capsule C in the inlet seat 103.

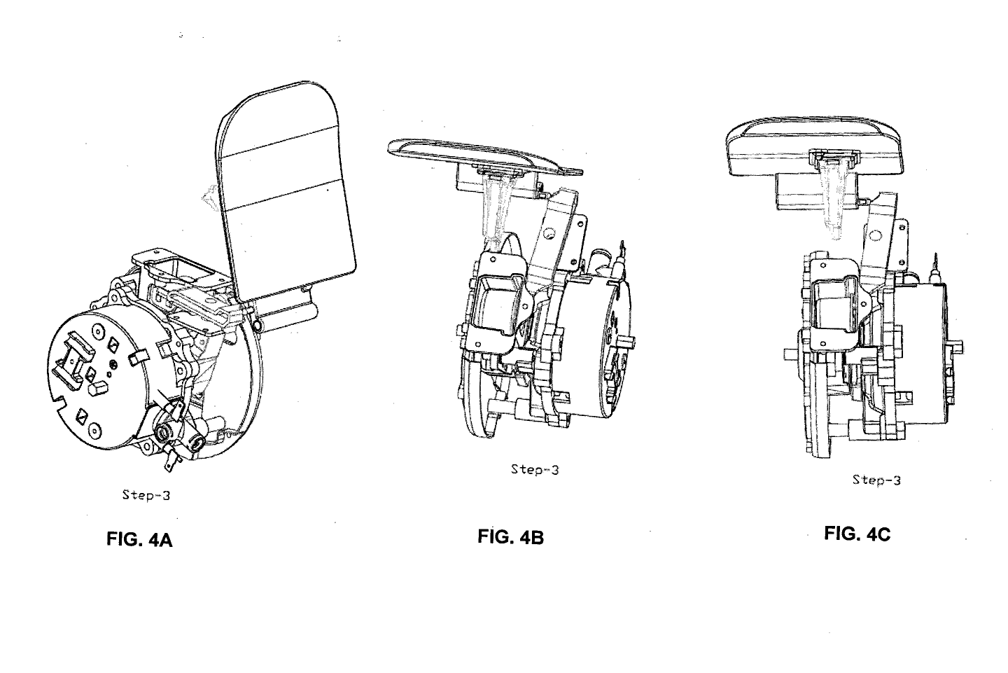

As shown in FIGS. 4A, 4B, 4C and 4D, the user proceeds then to rotate again the pushing lever 2 towards inlet seat 103, so that the engagement member 21 can indeed move the capsule towards the infusion seat 102 and within the latter. During such rotation motion of lever 2, and before the engagement member 21 interferes with the capsule, pin 24 of lever 2 engages the shaped surface 14 of lever member 11, so as to produce an approaching of the perforating members 13 to the capsule and then the penetration thereof in the opening 105 and in the capsule itself.

Still in its own motion for approaching to the inlet seat 103, after perforating lever 2 produces a removal of the perforating members 13 from the capsule, allowing the latter to move into the infusion seat 102.

The invention has been sofar described in association to a pushing lever which can be actuated manually to produce the capsule motion. However, the invention can apply even to the case of automatic systems for moving the capsule between an inlet position in the infusion group and an infusion position.

Furthermore, the invention has been described by referring to monolateral perforating means which act at a capsule top wall. Embodiment variants can provide bilateral perforating means, that is agents even at the capsule bottom or even still monolateral perforating means, but agents indeed at the capsule bottom.

The present invention has been sofar described by referring to preferred embodiments. It is to be meant that other embodiments belonging to the same inventive core can exist, as defined by the protection scope of the claims reported below.

1. An infusion group adapted for being used in a machine for supplying beverages such as coffee and the like starting from a granular preparation contained in capsules, which infusion group comprises:
an infusion seat, which is adapted to receive a capsule during beverage extraction, such beverage infusion being performed by means for feeding an infusion liquid through the capsule;
means for moving the capsule, adapted to move the capsule from an inlet position in the infusion group to an infusion position wherein the capsule is received in said infusion seat; and
perforating means of the capsule, distinct from the means for feeding an infusion liquid,
wherein the whole configuration is such that said perforating means perforates the capsule in a position of the capsule preceding said infusion position.

2. The infusion group according to claim 1, wherein the whole configuration is such that said perforating means perforates the capsule in an inlet seat corresponding to said inlet position and/or in a capsule position intermediate between said inlet position and said infusion position.

3. The infusion group according to claim 1, comprising shape coupling means for actuating said perforating means.

4. The infusion group according to claim 3, wherein said perforating means comprises a shaped surface.

5. The infusion group according to claim 4, wherein said shape coupling means comprises a pin member and a shaped surface configured for a mutual engagement.

6. The infusion group according to claim 1, wherein the whole configuration is such that said perforating means are actuated by said means for moving the capsule.

7. The infusion group according to claim 1, wherein said perforating means are rotatable to reach a perforating position.

8. The infusion group according to claim 7, wherein the whole configuration is such that said perforating means are actuated by said means for moving the capsule and wherein said perforating means is rotatable about a rotation axis substantially orthogonal to a rotation axis of said means for moving the capsule.

9. The infusion group according to claim 1, wherein said perforating means comprises contrast elastic means adapted to oppose a removal of such perforating means from a perforating position of the capsule.

10. The infusion group according to claim 1, comprising an opening for accessing the capsule for said perforating means.

11. The infusion group according to claim 1, wherein said perforating means comprises a lever member, bearing one or more perforating members.

12. The infusion group according to claim 1, wherein said perforating means comprises one or more elongate perforation members.

13. The infusion group according to claim 1, wherein said perforating means is bilateral, being suitable to act at two opposed walls of the capsule.

14. A machine for supplying beverages such as coffee starting from a granular preparation contained in capsules, comprising an infusion group according to claim 1.

15. The infusion group according to claim 9, wherein said contrast elastic means is arranged at a rotation axis of said perforating means.

16. The infusion group according to claim 11, wherein said lever member is a first class lever.

17. The infusion group according to claim 11, wherein said one or more perforating members is arranged at a longitudinal end portion of said lever member.
